(19) United States
(12) Patent Application Publication
(10) Pub. No.: US 2024/0292823 A1
(43) Pub. Date: Sep. 5, 2024

(54) FISHING ROD-ENCLOSING AND REEL-PROTECTING SYSTEM

(71) Applicant: Otilia Rochin de Herrera, Frazier Park, CA (US)

(72) Inventor: Otilia Rochin de Herrera, Frazier Park, CA (US)

(21) Appl. No.: 18/177,307

(22) Filed: Mar. 2, 2023

(51) Int. Cl. A01K 97/08

(52) U.S. Cl. CPC A01K 97/08

(57) ABSTRACT

A fishing rod-enclosing and reel-protecting system is disclosed. The system includes a bag sized for enclosing at least one fishing rod and its attached fishing reel. The bag, elongated and oriented along a longitudinal axis, has an opening oriented along the axis. The system includes an elongated zipper fixed to edge margins of the bag adjacent the opening and oriented along the axis. The zipper has opposite end portions and includes a spaced-apart pair of zipper pulls at each end of the zipper for enlarging the opening when the pulls are drawn apart or closing the opening when the pulls are drawn together.

### FIELD

The present subject matter is directed, in general, to fishing rod carrying cases and, more particularly, is directed to a fishing rod-enclosing and reel-protecting system.

### BACKGROUND

Damage to fishing rods and various reels when transported, stored, or exposed to many weather conditions is problematic. Attempts to solve these problems have resulted in fishing rod cases disclosed, for example, in U.S. Pat. No. 6,760,994 to Henault et al. and U.S. Pat. No. 6,789,713 to Redzisz. Other attempts to solve such problems have resulted in fishing rod-and-reel containers disclosed, for example, in U.S. Pat. No. 6,865,841 to Wiering. Additional attempts to solve these problems have resulted in foldable fishing-rod cases, disclosed, for example, in U.S. Pat. No. 11,344,015 to Zieg. Further attempts to solve these problems have resulted in integrated protective cases for fishing rods and reels including pre-tied lures disclosed, for example, in US published patent application 2021/0307309.

But, prior art solutions to problems disclosed, e.g., in patents noted above, provide rod-and-reel cases that totally enclose the reel portion of a rod-and-reel fishing assembly.

Cases that totally enclose can damage a reel portion of a rod-and-reel fishing rod.

According to an internet source (last updated Jul. 22, 2022), there are five different types of fishing reels: (1) spin cast fishing reels; (2) spinning fishing reels; (3) bait cast fishing reels; (4) so-called “conventional” fishing reels; and (5) fly fishing reels. These reels are available in various sizes; and each includes its own “very special components.”

Yet, U.S. Pat. No. 3,131,503 to Gottula, disclosing a fishing rod enclosure having an open end from which a reel portion and a handle of an assembled rod-and-reel fishing rod extends, may damage a guide located at the tip of a rod or larger guides along the length of the rod, because the enclosure is made of small-diameter, rigid tubular material.

While U.S. Pat. No. 5,515,641 to D'Alessandro discloses an enclosure made of a pliable material, the open end-portion of this enclosure has the reel portion and handle of an assembled rod-and-reel fishing rod extending therefrom, which enables the handle to become damaged when transported, stored, or exposed to inclement weather conditions.

Further in this regard, dual enclosure construction, with one enclosure being for a rod and the other enclosure being for a handle, with both enclosures only temporarily connected, as disclosed in U.S. Pat. No. 6,408,564 to Murphy, or never connected, as disclosed in U.S. Pat. No. 6,318,019 to Harris, requires fishing enthusiasts to keep track of both enclosures, posing yet another problem that is unappreciated by fishing enthusiasts. Furthermore, the connector disclosed in US published patent application 2018/0192629 to Arnold, connecting two hollow tubes, each being open at one end and closed at the opposite end merely presents fishing enthusiasts with some of the problems above-noted, since tubular construction can damage a tip guide or other guides along a length of a rod.

Many fishing enthusiasts consider the spinning reel to be the most popular type of fishing reel currently available. A typical spinning reel has a main body portion unitary with a foot portion secured to and extending about 3 to 4 inches from a handle portion of an attached fishing rod. A line spool and other spinning reel components extend from the main body portion in the direction of the tip guide of a rod. Conventional trolling reels, made of heavy-duty graphite, machined aluminum, and having a semi-open design and oversized handle and reel crank to provide mechanical advantage, are often used by fishing enthusiasts for reeling in deep sea game fish including tuna, marlin, and snapper. Conventional fishing and spinning rod-and-reel assemblies—especially the reel portion—can be damaged when transported, stored, or exposed to inclement weather conditions.

During the course of many fishing expeditions, when fish sought by an enthusiast suddenly appear and time is of the essence, it would be desirable for there to be available (for purchase) an enclosure for a connected rod-and-reel assembly that allows the reel portion of the assembly to extend outwardly from the enclosure and also allows the user to quickly remove the rod portion of the assembly (and its handle) from the protective enclosure, assured the enclosure protected and caused no damage to the rod or the reel.

The present subject matter is directed in general to fishing rod carrying enclosures and, more particularly, is directed to a fishing rod-enclosing and reel-protecting system.

### SUMMARY

The present subject matter is directed to a fishing rod-enclosing and reel-protecting system which includes a bag or envelope made, sized, adapted, and configured for enclosing at least one fishing rod to which a fishing reel is attached. The bag, elongated and oriented along an axis, includes an opening oriented along the axis. The system includes an elongated slide fastener fixed to the bag adjacent to the opening and oriented along the axis. The slide fastener has opposite end portions and includes a spaced-apart pair of slide fastener pulls located at each end portion for enlarging the opening when the fastener pulls are drawn apart or closing the opening when the pulls are drawn together.

One or more fishing rods, securely enclosed within the bag, are not damaged when the bag, made from flexible high-strength canvas or Cordura®, a durable synthetic fabric, is transported, stored, or exposed to inclement weather conditions. Reels attached to the one or more rods and extending through the opening, are not damaged by the bag. Finally, fishing enthusiasts appreciate a time-saving convenience of having reels attached to associated fishing rods.

### BRIEF DESCRIPTION OF THE FIGURES

FIG. 1 is a top front perspective view of a fishing rod-enclosing and fishing reel-protecting system according to an embodiment of the present subject matter, shown in use;

FIG. 2 is a detail perspective view thereof;

FIG. 3 is an exploded perspective view, showing the fishing rod-enclosing and fishing reel-protecting system in an open condition;

FIG. 4 is another perspective view thereof;

FIG. 5 is yet another perspective view thereof, shown in a closed condition without a fishing rod;

FIG. 6 is yet another perspective view thereof; and

FIG. 7 is another perspective view thereof, shown in use with a shoulder strap installed.

Throughout the FIGS. and detailed description in this patent application, I shall use similar reference numerals to refer to similar components of the present subject matter.

### DETAILED DESCRIPTION

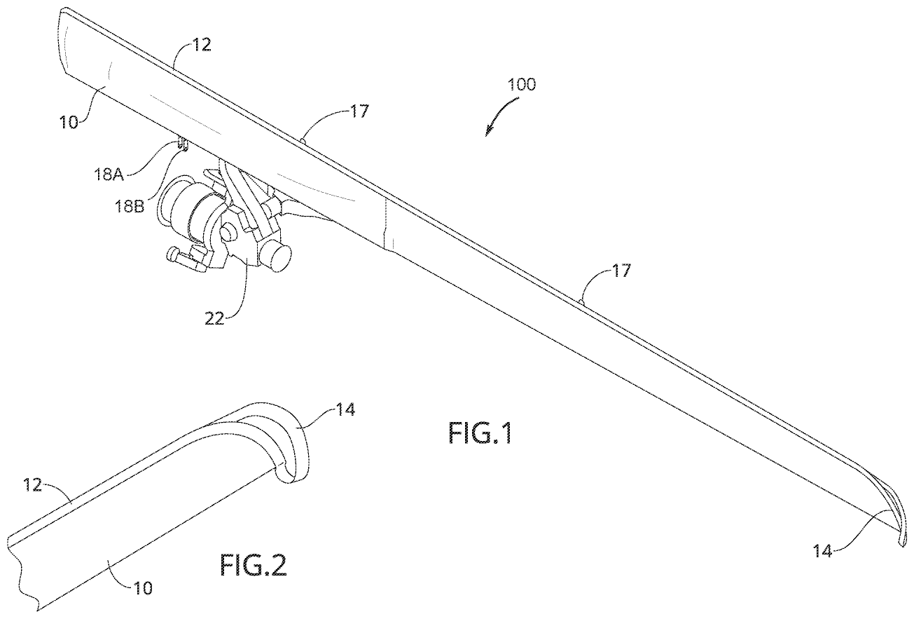

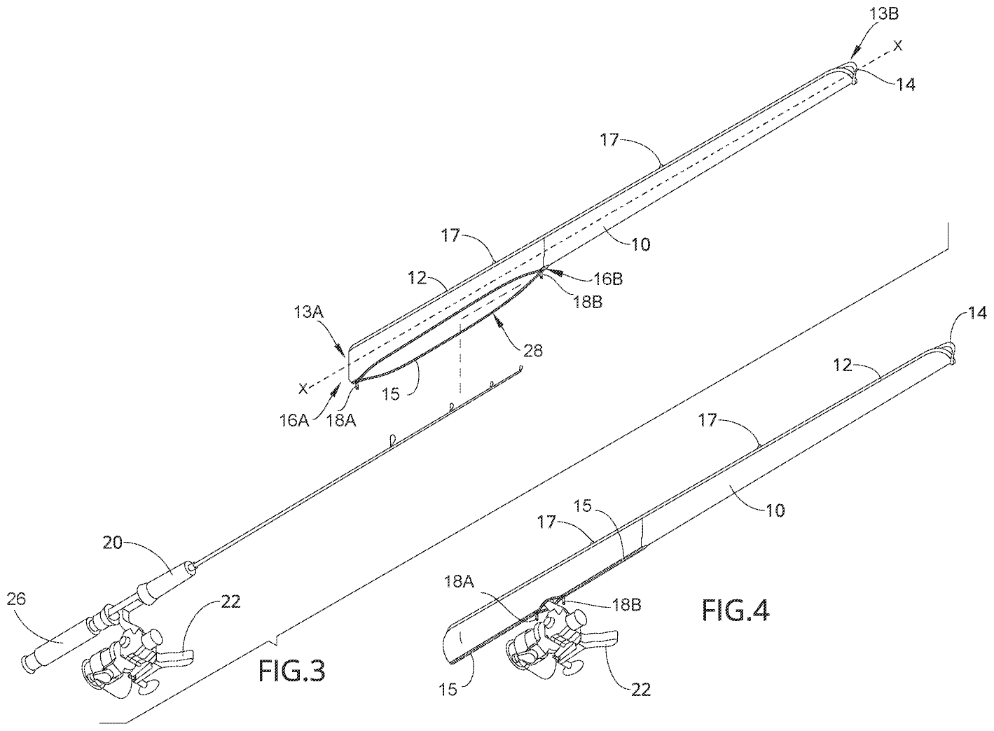

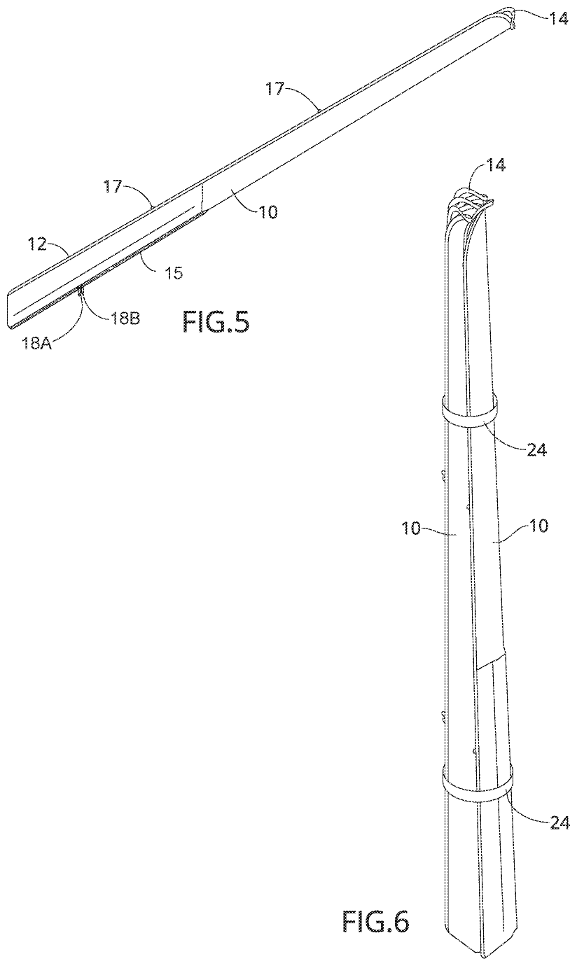

An illustrated fishing rod-enclosing and reel-protecting system 100 of the present subject matter is shown in FIG. 1 and shall now be described in detail. The system 100 includes an elongated bag or envelope 10 (FIGS. 5, 6) preferably manufactured of fabric. The bag or envelope 10 is sized, adapted, and configured for enclosing at least one fishing rod 20 (FIG. 3) to which a fishing reel 22 (FIG. 1) is attached. The bag or envelope 10, elongated and oriented along an axis X-X (FIG. 3), includes an opening 28 (FIGS. 3, 4) oriented along the axis X-X. The system 100 includes an elongated slide fastener 15, such as an elongated zipper 15, (FIGS. 3, 4) secured to the bag 10 and located closely adjacent to the opening 28. The zipper 15 is preferably oriented along the axis X-X. The bag or envelope 10 has opposite end portions 13A, 13B (FIG. 3) and is made of canvas or Cordura®. Canvas—a strong, coarse, unbleached cloth made from hemp, flax, linen or cotton, or a similar yarn—is often used to make such articles as sails and tents. Cordura® fabrics, usually made of nylon, can be a blend of nylon with cotton or other natural fibers. The bag 10 has spaced apart strap attachment loops 17 joined to a longitudinal edge opposite the edge having the zipper 15.

The bag or envelope 10 is dimensioned and configured to contain and enclose one or more fishing rods 20 oriented longitudinally along the axis X-X. The one or more fishing rods 20 each has a handle 26 (FIG. 3). The bag or envelope 10 has an opening 28 oriented along the axis X-X (FIG. 3) and located along one 13A of the end portions 13A, 13B of the bag or envelope 10 (FIG. 3). The elongated slide fastener mechanism 15 is secured to edge margins of the bag or envelope 10 adjacent the opening 28. The slide fastener mechanism 15 has opposite end portions 16A, 16B (FIG. 3) and includes a spaced-apart pair of slide fastener pulls 18A, 18B (FIG. 3) respectively located at each mechanism end portion 16A, 16B (FIG. 3). Even though only one rod 20 and attached reel 22 is shown in FIGS. 1, 3, and 4, the mechanism 15 is configured—when each of the one or more enclosed rods 20 includes an attached reel 22—whereby the pulls 18A, 18B can be drawn together by a user to reduce a size of the opening 28 to allow only the one or more reels 22 to extend outwardly through the opening 28 from bag or envelope 10 while the handle 26 of each of the rods 20 remains enclosed within the bag or envelope 10. Otherwise, when a user draws the pulls 18A, 18B together and no reel is attached to any of the enclosed fishing rods 20, the pulls 18A, 18B are used to close the opening 28.

Additional features of the present subject matter shall now be described. The elongated bag or envelope 10 is preferably made from a waterproof fabric. Longitudinal end margins of the bag or envelope 10 are preferable secured by grosgrain binding 12 (FIGS. 1, 3, 4, 5) to seal a bag or enclosure 10. Grosgrain is a type of fabric or ribbon defined by the fact that its weft is heavier than its warp, creating prominent transverse ribs. Grosgrain, a plain weave corded fabric, has heavier cords than poplin but lighter than faille, and is known for being a firm, close-woven, fine-corded fabric. While grosgrain often has a dull appearance, with little luster in comparison to many fabric weaves, e.g., satin, and is often used for ribbons, grosgrain is comparatively very strong. The term “grosgrain” is often used to refer to a heavy, stiff ribbon of silk or nylon woven via taffeta weave using a heavy weft, resulting in distinct transverse ribs. Historically, grosgrain was made from wool, silk, or a combination of fibers such as silk and wool or silk and mohair.

The system 100 of the present subject matter includes a hanging loop 14 (FIG. 1) and straps 24, enabling a fishing enthusiast or other user to carry multiple bags 10 at one time. See FIG. 6.

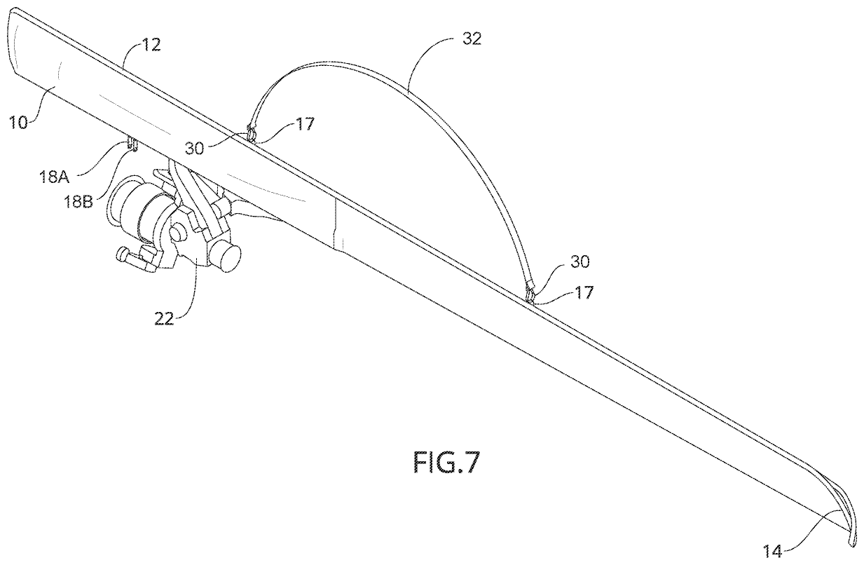

As seen in FIG. 7, the system 100 further comprises a shoulder strap 32 with a clip 30 at each end. The clips 30 couple to the strap attachment loops 17.

Described in detail hereinabove is a fishing rod-enclosing and reel-protecting system. While the present subject matter has been described in connection with a presently illustrated embodiment, the present subject matter is not limited to this embodiment. On the contrary, many alternatives, changes, and/or modifications shall become apparent to a person of ordinary skill in the in the art (“POSITA”) after this patent specification has been reviewed in connection with its associated figures. Therefore, all alternatives, changes, and modifications are to be treated as forming a part of the present subject matter insofar as they fall within the spirit and the scope of the appended claims.

I claim:

1. A fishing rod-enclosing and reel-protecting system (100) comprising:
an elongated fabric envelope (10) defining an axis X-X, wherein the envelope (10) has opposite end portions (13A, 13B), wherein the envelope (10) is operative to accommodate one or more fishing rods (20) having a handle (26) and a reel (22), oriented longitudinally along the axis X-X, wherein the envelope (10) defines an opening (28) oriented along the axis X-X and located along one (13A) of the end portions (13A, 13B) thereof; and
an elongated slide fastener mechanism (15) secured to edge margins of the envelope (10) adjacent the opening (28), wherein the mechanism (15) has opposite end portions (16A, 16B) and includes a spaced-apart pair of slide fastener pulls (18A, 18B) respectively located at each mechanism end portion (16A, 16B) when in an open position, and wherein the mechanism (15) is configured and adapted such that the pulls (18A, 18B), when drawn together, reduce a size of the opening (28) to allow only the one or more reels (22) to extend therethrough outwardly from the envelope (10), while the handle (26) of each of the one or more rods (20) remains enclosed within the envelope (10); and wherein the pulls (18A, 18B are operative to close the opening (28) when the pulls (18A, 18B) in the absence of a reel (22).

2. The fishing rod-enclosing and reel-protecting system (100) of claim 1, wherein the fabric envelope (10) is waterproof.

3. The fishing rod-enclosing and reel-protecting system (100) of claim 1, wherein the slide fastener mechanism (15) is a zipper.

4. The fishing rod-enclosing and reel-protecting system (100) of claim 1, further including a spaced-part pair of straps (24) operative to encompass more than one of the elongated fabric envelope (10).

5. The fishing rod-enclosing and reel-protecting system (100) of claim 1, wherein the elongated fabric envelope comprises canvas or a durable synthetic fabric.
